(19) United States
(12) Patent Application Publication
(10) Pub. No.: US 2003/0205002 A1
(43) Pub. Date: Nov. 6, 2003

(54) Sliding door assembly for H-frame merchandiser

(76) Inventor: Raymond John Gradecki, Mundelein, IL (US)

Correspondence Address: Daniel N. Christus, Esq., Wallenstein & Wagner, Ltd., 53rd Floor, 311 South Wacker Drive, Chicago, IL, 60606-6630, US

(21) Appl. No.: 10/136,686

(22) Filed: May 1, 2002

(51) Int. Cl. E05D 13/00

(52) U.S. Cl. 49/409; 49/125

(57) ABSTRACT

The invention is a sliding door assembly for an H-frame rack system. The H-frame rack system includes a plurality of substantially vertical posts, and a plurality of substantially horizontal beams connected to these vertical posts. Merchandise-carrying shelves are supported by the horizontal beams. The sliding door assembly includes at least one sliding door. Rollers are secured to the sliding door or doors for facilitating lateral movement of the sliding doors along the H-frame rack system. Channels secured to at least one of the horizontal beams are positioned above the sliding doors. The rollers are guided within these channels.

### TECHNICAL FIELD

This invention relates to a sliding door assembly for use with an H-frame rack system.

### BACKGROUND OF THE INVENTION

H-frame rack systems or H-frame display units are commonly used in large, high-ceilinged stores that sell hardware, paint, and other high-volume products to the public. These H-frame display units are shown, for example, at FIGS. 6 and 7 of U.S. Pat. No. 5,918,750, issued to Donald A. Jackson on Jul. 6, 1999.

These H-frame rack systems include several substantially vertical posts. These posts may be installed into a base. Alternatively and more typically, these vertical posts are permanently and rigidly attached to the concrete floor at these stores. A number of substantially horizontal beams are connected to these vertical posts. Substantially horizontal shelves, which may be of a grid-type or a solid plate-type structure, are supported by the horizontal beams. Merchandise is placed upon these horizontal shelves.

Commonly, there are several vertically spaced-apart horizontal beams, and several correspondingly vertically spaced-apart horizontal shelves. The lower-most shelves are at and below eye-level. Thus, merchandise that is placed upon these lower-most shelves is readily accessible to retail shoppers.

In contrast, the higher horizontal shelves are too high to permit shoppers to reach merchandise placed upon those shelves. In fact, the merchandise on these shelves is often not intended to be accessed by shoppers. Instead, such merchandise is intended to be the source of restocking when the merchandise on the lower level shelves has been sold.

In some instances, the more highly positioned merchandise is so far above eye-level that it cannot readily be seen by those shoppers. As a result, many retailers whose stores include H-frame rack systems place doors in front of the upper portion of these H-frame rack systems. Such doors obscure the highly positioned merchandise, providing the store with a cleaner, more uncluttered appearance. In addition, the face of these doors can support advertising and promotional placards.

The doors that are currently used for H-frame rack systems are pivoting doors. In two-door pivoting door structures, each door is hinged so that the door swings outwardly, like the doors of a typical barn. In one-door pivoting door structures, the door is hinged at its bottom, so that the door swings downwardly, like the tailgate of a pick-up truck. Alternatively, the door may be hinged at its top, so that it swings upwardly about a pivot point that is positioned above the door.

These two kinds of prior art doors have certain disadvantages. The most significant disadvantage is that these doors extend into the adjacent store aisle, i.e., the doors extend beyond a vertical plane extending between adjacent vertical posts of the H-frame rack system. Because doors opened in this manner can extend into the store aisle, they can be and have been struck, causing damage to the doors. For example, these doors can be damaged by passing forklifts, consumers with shopping carts containing tall merchandise, or by the portable, wheeled ladders that are commonly used by the workers in such stores to access the merchandise on the highest shelves. Such opened or damaged doors also create a risk to persons in their vicinity.

These doors are also heavy. This increases the strain on the hinges that hold the doors, and increases the potential damage that can be done to objects or persons that strike them. These prior art doors are also subject to warpage, which can make them difficult or impossible to align. As a result, unsightly and uneven gaps can arise between the doors.

Accordingly, it would be desirable to create an improved door system for H-frame display units that overcomes these deficiencies.

### SUMMARY OF THE INVENTION

The invention is a sliding door assembly for an H-frame display unit, also known as an H-frame rack system. The H-frame rack system includes a plurality of substantially vertical posts, and a plurality of substantially horizontal beams connected to these vertical posts. Substantially horizontal shelves for the placement of merchandise are supported by these horizontal beams.

The assembly includes at least one sliding door. Rollers are secured to the sliding door or doors for facilitating lateral movement of those sliding doors along openings of the H-frame rack system. Channels are positioned above the sliding doors. Those channels are secured to at least one of the horizontal beams. The rollers, and thus the doors, are guided by these channels.

In one embodiment of the invention, the sliding doors are positioned inboard of a vertical plane extending between adjacent vertical posts.

This first embodiment may include at least three (3) doors. In yet another aspect of the invention, those three (3) doors are all of approximately the same length.

In yet another aspect of this invention, the height of the sliding doors is adjustable. In order to adjust the doors, the doors include a plurality of panels: an upper panel, a middle panel, and a lower panel. Preferably, the upper and lower panels are fixed. The middle panel is vertically adjustable relative to the upper panel and the lower panel. Preferably, the middle panel attaches to the upper and lower panels through concentric placed apertures in the two panels. Fasteners are placed through the concentric placed apertures in the middle and upper panels, and through the middle and lower panels, respectively.

The doors of the preferred sliding door assembly include a frame portion. The frame portion includes two oversized vertical frame members. These oversize frame members may be cut to accommodate the different door heights that result from the movement of the middle panels relative to the upper and lower panels, respectively.

In a second embodiment of the invention, these sliding doors are supported by a separate frame secured to the vertical beams of the H-frame rack system.

### BRIEF DESCRIPTION OF THE DRAWINGS

FIG. 1 is a perspective view of an assembled version of the first embodiment of the sliding door assembly for the top section of an H-frame display unit, this display unit having a horizontal opening of approximately 102 inches.

FIG. 2 is a front view of the assembly and display unit of FIG. 1.

FIG. 3 is a side, sectional view of the assembly and display unit of FIG. 1, showing a graphics panel in addition to the structural panels for the sliding doors.

FIG. 4 is a partially exploded perspective view of a corner portion of one of the three sliding doors.

FIG. 5 is a perspective view of a corner portion of one of the three sliding doors, showing that door after assembly, and after the cutting of the oversized vertical frame member.

FIG. 6 is a partial, horizontal sectional view taken along lines 6-6 of FIG. 2.

FIG. 7 is a front view of one of the sliding doors of FIG. 1, but shown with an increased height, as a result of the adjustment of the middle panel, relative to the upper panel and the lower panel.

FIG. 8 is a front view of the three sliding doors of the embodiment of FIG. 1, but placed in an H-frame display unit having a horizontal opening of approximately 99 inches.

FIG. 9 is a front view of the three sliding doors of the embodiment of FIG. 1, but placed in a H-frame display unit having a horizontal opening of approximately 97 inches.

FIG. 10 is a front view of the three sliding doors of the invention of FIG. 1, but superimposed upon each other by moving them to their far left position, to create the maximum horizontal opening for either stocking or unloading the contents of the H-frame display unit of the invention.

FIG. 11 is a perspective view of an assembled version of the second embodiment of the sliding door assembly for the H-frame display unit.

FIG. 12 is a enlarged, partial sectional front view of a portion of the structure shown in FIG. 11.

FIG. 13 is a side, partially sectioned view of a portion of the apparatus shown in FIG. 11.

FIG. 14 is a side, partially sectioned view of the same portion of the apparatus shown in FIG. 13, but with its rigid frame mounted at a higher position upon the vertical posts of the H-frame display unit.

FIG. 15 is a front view of the rigid frame of the embodiment of FIG. 11.

FIG. 16 is a side view of the rigid frame of FIG. 15.

FIG. 17 is a front view of the structural panel of the sliding door shown in FIGS. 13 and 14.

FIG. 18 is a side view of the structural panel of FIG. 17, but also showing certain extruded framing elements that both surround and hold the structural panel, and a graphics panel.

### DETAILED DESCRIPTION

This invention may be made in any of several different embodiments. The drawings and this specification will describe in detail two preferred embodiments of the invention. It should be understood, however, that the disclosure is to be considered as but two examples of the principles of the invention. This disclosure is not intended to limit the broad aspect of the invention to the two illustrated embodiments.

First Embodiment of the Invention

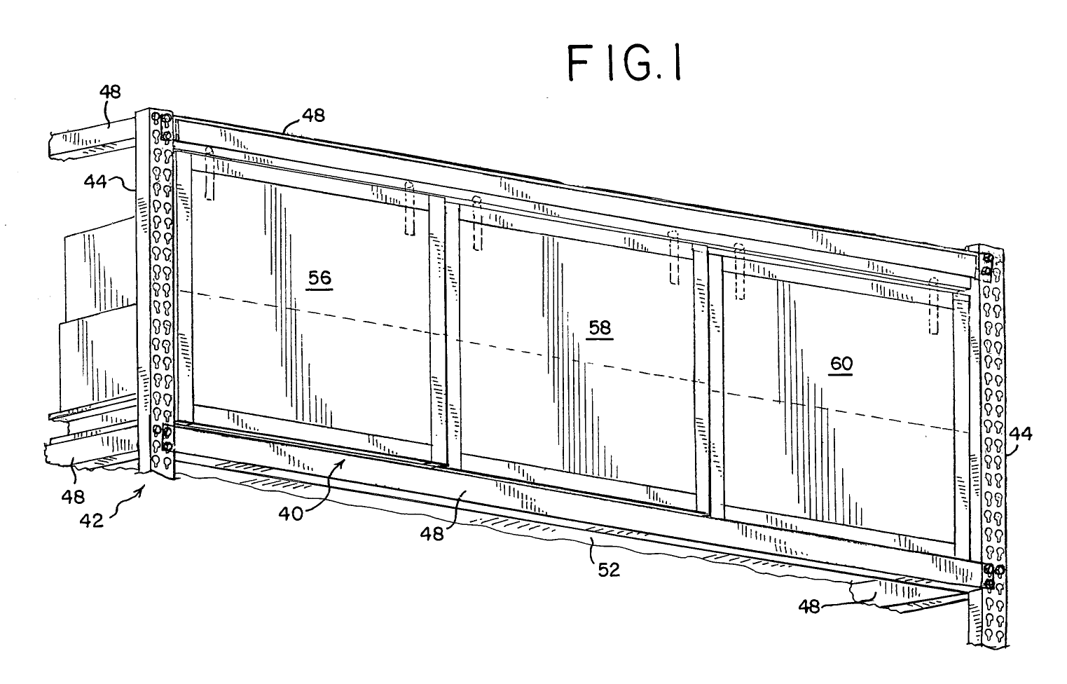

Referring to the drawings, FIG. 1 provides a perspective view of an assembled version of a first embodiment of the invention. The invention is sliding door assembly 40 for an H-frame display unit, also referred to in this description as an H-frame rack system 42. These H-frame display units 42 are commonly used in high-ceilinged, retail warehouse-type stores.

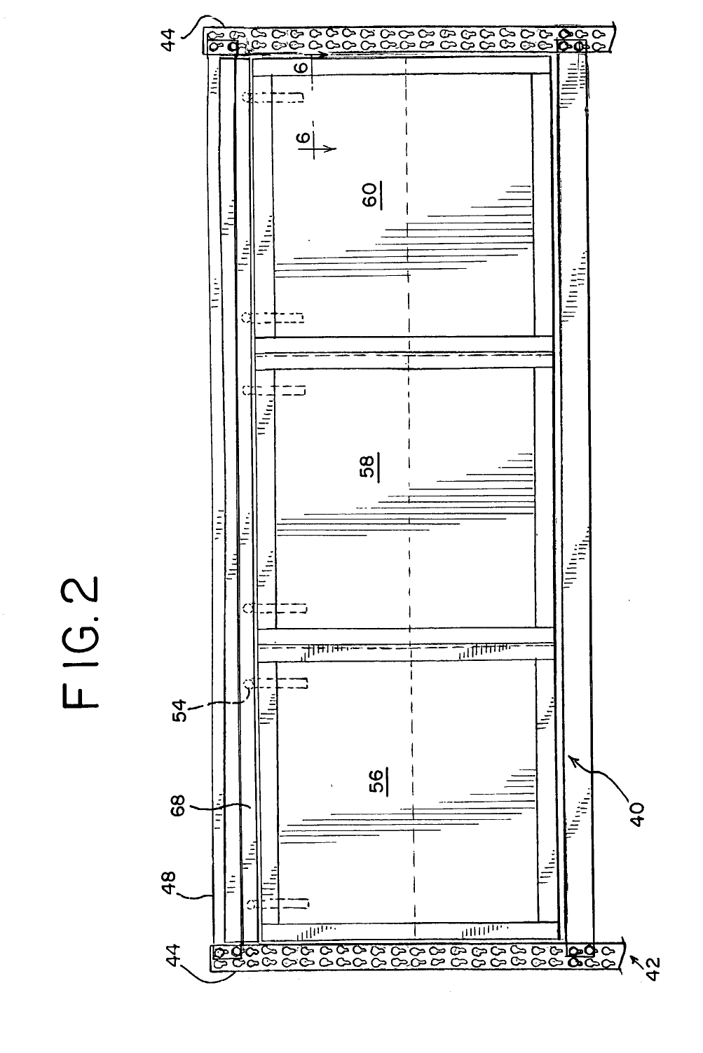

As may be seen in FIGS. 1 and 2, the H-frame rack system 42 includes a plurality of substantially vertical posts 44. These vertical posts 44 are load-bearing members for the H-frame rack system 42.

These vertical posts 44 may be installed into a base. More typically, however, these vertical posts 44 are permanently and rigidly attached to the concrete floor at the stores in which they are used.

As may also be seen in FIG. 1, a number of substantially horizontal beams 48 are connected to these vertical posts 44. These horizontal beams 48 are secured to the posts 44 with mounting hardware, including but not limited to nuts and bolts or rivets. The beams 48 and posts 44 form a strong, lightweight structure that serves as a platform on which to place merchandise.

FIG. 1 also shows that this merchandise is supported by substantially horizontal shelves 52. These shelves 52 may be of a grid-type, or a solid plate-type, structure. As may also be seen in FIG. 1, these shelves 52 are typically supported by, placed upon, and secured to the horizontal beams 48.

Commonly, there are two to four vertically spaced-apart rows of horizontal beams 48 on each of the H-frame rack systems 40. There are a corresponding number of vertically spaced-apart shelves 52. The lower-most shelves (not shown) are either at the eye-level or below the eye-level of the typical shopper. Thus, merchandise that is placed upon these lower-most shelves is easily accessible to shoppers at these stores.

In contrast, the more highly positioned horizontal shelves 52 of FIG. 1 are too high to hold merchandise that shoppers can normally reach. In fact, the merchandise on these shelves 52 is often not intended to be accessed by shoppers. Instead, merchandise on such higher shelves 52 is intended to be used for restocking the lower shelves when the merchandise at the lower levels is exhausted.

The sliding door assemblies 40 of the present invention can be used on either the upper or lower shelves of the H-frame rack system 42. It is contemplated, however, that the sliding door assemblies 40 of the invention will more typically be used in connection with the upper shelves. In this first embodiment, as may best be seen in FIGS. 1, 2, and 10, the sliding door assembly 40 of the invention is positioned to obscure the merchandise on the upper level shelves of the H-frame rack system 42.

The sliding door assembly 40 of this invention should have at least one sliding door. In this preferred embodiment, however, the sliding door assembly 40 includes three sliding doors 56, 58, and 60. These three sliding doors 56, 58, and 60 each preferably have an overall length of 34½ inches.

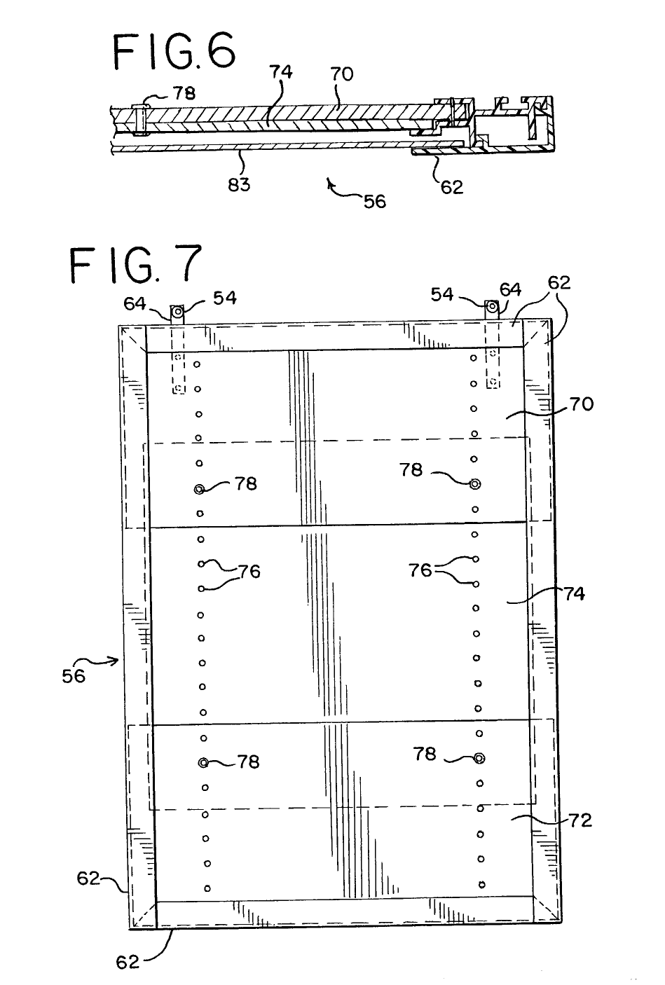

As may be seen in FIGS. 5 and 7, each of the sliding doors includes a rectangular frame portion 62. In this embodiment, a four-sided, rectangular frame portion 62 forms the outer periphery of each of the rectangular sliding doors 56, 58, and 60. The rectangular frame portion 62 has a width of approximately 2⅜ inches.

If the three sliding doors 56, 58, and 60 were placed side to side, with no overlapping of the adjacent frame portions 62, those doors could cover an opening of three times their 34½ inch lengths, i.e., openings of 103½ inches. By overlapping parts of the frame portions 62 of the adjacent sliding doors 56, 58, and 60, those sliding doors can neatly accommodate smaller openings, as well. In fact, by overlapping varying amounts of the adjacent frame portions 62 of doors 56, 58, and 60, as shown in FIGS. 1, 8, and 9, respectively, the sliding doors can easily accommodate the standard openings between adjacent vertical posts 44 of the H-frame rack systems 42. The standard openings between the adjacent vertical posts 44 are typically either 97 inches, 99 inches, or 102 inches.

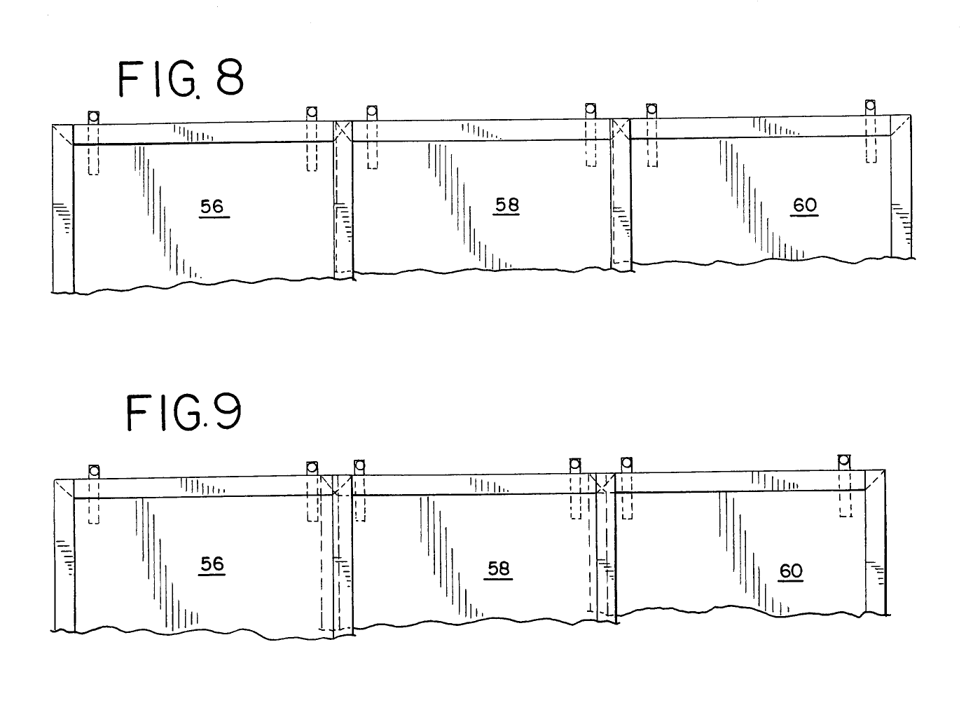

FIG. 1 shows the sliding doors positioned relative to each other with very little overlap, to accommodate an H-frame display unit having a horizontal opening of approximately 102 inches. FIG. 8 shows the sliding doors positioned relative to each other with somewhat more overlap, to accommodate an H-frame display unit having a horizontal opening of approximately 99 inches. FIG. 9 shows the sliding doors positioned relative to each other with even more overlap, to accommodate an H-frame display unit having a horizontal opening of approximately 97 inches.

Hence, it can be seen that the present invention solves the problem of gaps that occasionally arise as a result of the fixed panel sizes of prior art hinged doors.

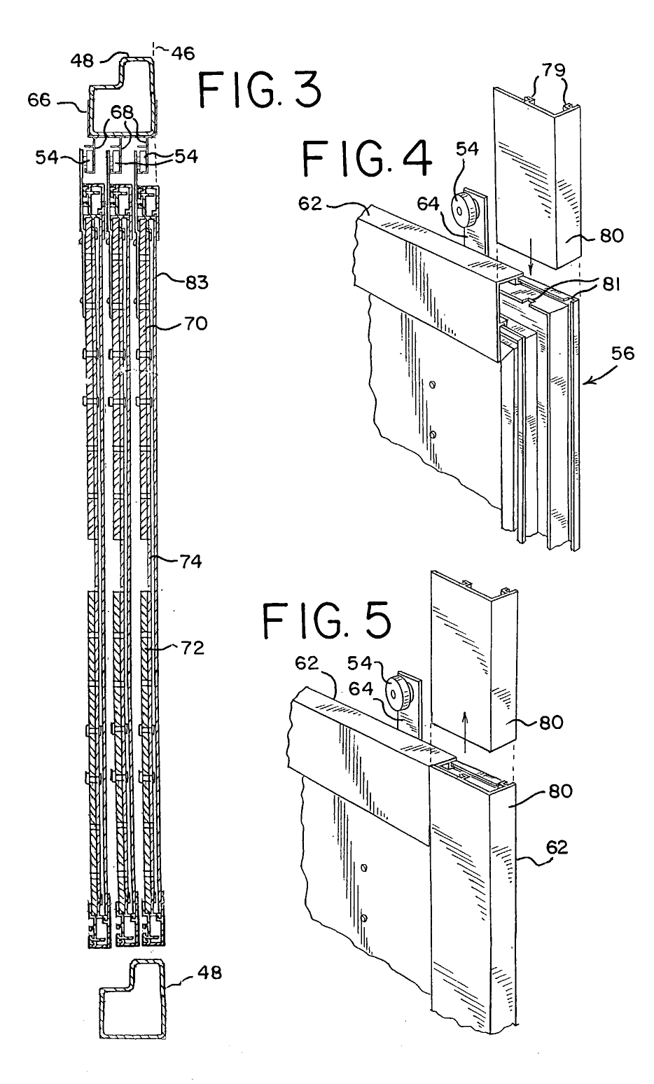

As may be seen in FIGS. 3, 4, 5, and 7, the sliding door assembly 40 includes rollers or wheels 54. As may be seen in FIG. 7, two of these rollers 54 are provided for each of the sliding doors. These rollers 54 are secured to the sliding doors 56, 58, and 60 by a shallow, S-shaped bracket 64. The rollers 54 rotate about an axle that connects the rollers 54 to the bracket 64.

These rollers 54 facilitate lateral movement of the sliding doors 56, 58, and 60 along the H-frame rack system 42. As may best be seen in FIG. 3, an elongated C-shaped channel piece 66 is positioned above the sliding doors. As may also best be seen in this FIG. 3, each C-shaped channel piece 66 includes three J-shaped tracks 68, one for each of the sliding doors 56, 58, and 60. The C-shaped channel piece 66 fits tightly around and is secured to the bottom of one of the top-most horizontal beams 48. The rollers 54 and the sliding doors to which they are attached are guided along the J-shaped tracks 68.

In this first embodiment, described above and shown in FIGS. 1-10, virtually all of the structure of the sliding doors 56, 58, and 60 is positioned inboard of a vertical plane 46 extending from the front surface of the horizontal beam 48. A portion of this vertical plane 46 is best seen in the dotted lines extending through the front face of the horizontal beam 48 shown in FIG. 3. This inboard positioning of the doors 56, 58, and 60 keeps them safely tucked away, largely within the confines of the H-frame rack system 42, whether the sliding doors are opened or closed. Accordingly, unlike the hinged doors of the prior art described above, the sliding doors 56, 58, and 60 of the present invention are neither vulnerable to breakage, nor serve as potential hazards, when opened.

The sliding door assembly 40 of the present invention also includes a feature that permits the height of the sliding doors 56, 58, and 60 to be adjusted. The ability to adjust the heights of these doors permits the sliding door assemblies 40 to be used with H-frame rack systems 42 where there are varying, non-standardized distances between the vertically adjacent shelves 52.

To effect adjustment of the doors, as may best be seen in FIG. 7, the doors 56, 58, and 60 include a plurality of panels. In FIG. 7, door 56 is shown in a lengthened state. Door 56, like doors 58 and 60, includes a fixed upper panel 70, a fixed lower panel 72, and an adjustable middle panel 74. Preferably, the adjustable middle panel 74 attaches to the fixed upper 70 and fixed lower panels 72 through concentrically aligned apertures 76. The apertures 76 are formed in all three of these panels 70, 72, and 74.

In order to adjust the vertical heights of the doors, apertures 76 of the middle panels 74 are concentrically aligned with differing apertures in the fixed upper panel 70 and the fixed lower panel 72. The height of the sliding doors 56, 58, and 60 will depend on which of the apertures 76 in the adjustable middle panel 74 is aligned with particular apertures in the fixed upper panel 70 and fixed lower panel 72. The doors shown in FIGS. 1 and 2 represent an alignment of apertures (not shown) which will result in a door having a relatively lower height, while FIG. 7 shows alignment of the apertures 76 which will result in a door having a relatively greater height. It will be apparent to those of skill in the art that by changing the alignment of the apertures 76 in panels 70, 72, and 74, the door 56 of FIG. 7 can be made slightly taller or considerably shorter.

Fasteners 78 are placed through the concentric apertures 76 in the middle 74 and upper panels 70, and through the middle 74 and lower panels 72, respectively. These fasteners 78 can include any of the fasteners 78 typically used by those of skill in the art, such as rivets or nuts and either screws or bolts.

As a result of the above-described construction for this first preferred embodiment, the height of the doors 56, 58, and 60 can be varied between 32 inches and 48 inches, in 2″ increments, using only four (4) fasteners per door.

As noted above, the doors 56, 58, and 60 of the preferred sliding door assembly 40 include a frame portion 62. As may be seen in FIGS. 4 and 5, each four-sided frame portion 62 includes two oversized vertical frame members 80. As may be seen in FIG. 4, this oversized frame member 80 is positioned adjacent and then slides over the underlying structural portion of the door 56, utilizing a tongue and groove construction. The tongue portion 79 is integrally formed on the backside of the frame member 80, and the groove portion 81 is formed in the underlying structural portion of the door 56.

After the oversize frame member 80 has been fully inserted, as may be seen in FIG. 5, a portion of that frame member 80 extends beyond the perimeter of the rectangular frame 62. The oversize frame member 80 is long enough to accommodate the tallest possible door that can be formed by varying the positions of panels 70, 72, and 74. As may also be seen in FIG. 5, the portion of the oversize frame member 80 that extends beyond the perimeter of the rectangular frame 62 may be cut, as for example with a utility knife, to accommodate the different possible door heights. FIG. 5 shows the oversized frame member 80 after the excess has been cut away.

It will be clear from the above that these doors 56, 58, and 60 can be broken down into their component pieces, for easier shipment from the manufacturer to the end user. In addition, it will be clear that the height of the doors 56, 58, and 60 can be adjusted to a variety of heights at the site at which the door is used. Finally, it is clear that the fully assembled door can be broken down into its component parts, over and over again, and then reassembled.

As explained above and as may be seen in various of the FIGURES, and especially FIGS. 3 and 6, the doors 56, 58, and 60 include structural fixed upper panel 70, fixed lower panel 72, and adjustable middle panel 74. FIG. 6 shows door 56, and its panels 70 and 74. In addition, however, as may be seen in FIGS. 3 and 6, the doors also include graphics panels 83. These graphics panels 83 may be used to depict advertising or promotional messages. The graphics panels 83 are positioned beneath, and held in place by frictional engagement with, the rectangular frame 62. In the embodiment shown in FIG. 6, the graphics panels 83 may alternatively be securely held in place with staples.

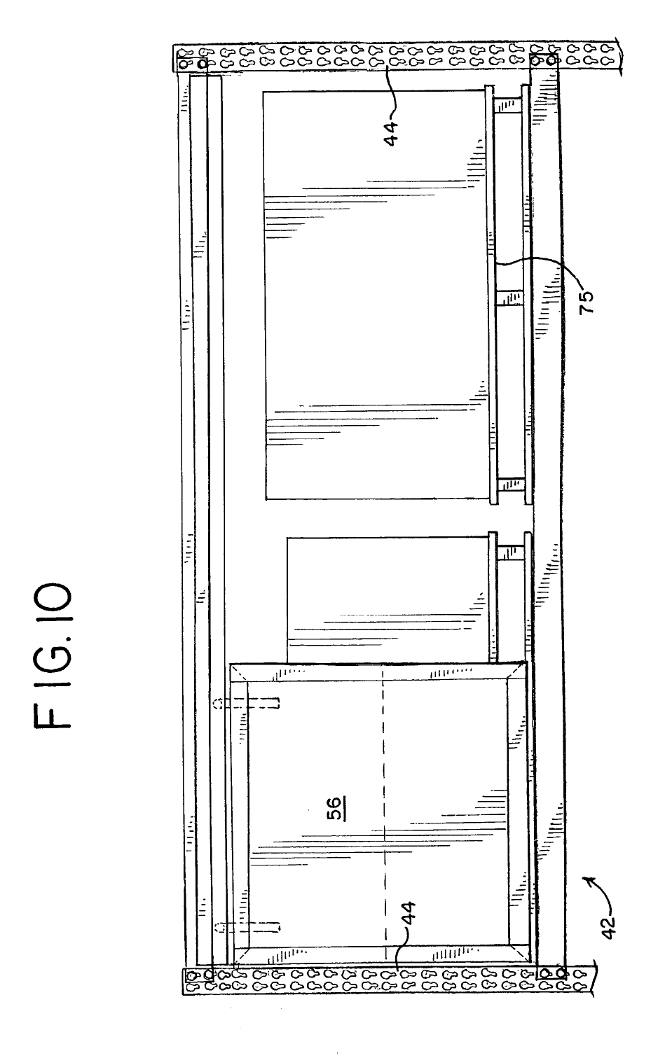

FIG. 10 shows the three sliding doors 56, 58, and 60 of this embodiment in a superimposed position, i.e, all three of the doors are moved to a far left position within the H-frame rack system 42. Given the 34½-inch lengths of the doors 56, 58, and 60, the movement of all three doors to the far left position of FIG. 10 provides a horizontal opening in this H-frame rack system 42 of approximately sixty-eight inches (68″), more than enough of an opening to permit the easy insertion and withdrawal of the typical, merchandise-laden four-foot (48″) wide pallet 75.

It will be apparent by this description that the present invention facilitates the changing of the graphics panels 83 so that different promotional messages can be periodically displayed. The fact that the promotional message is not a part of the structural components of the door permits the panel 83 and its message to be easily changed.

Second Embodiment of the Invention

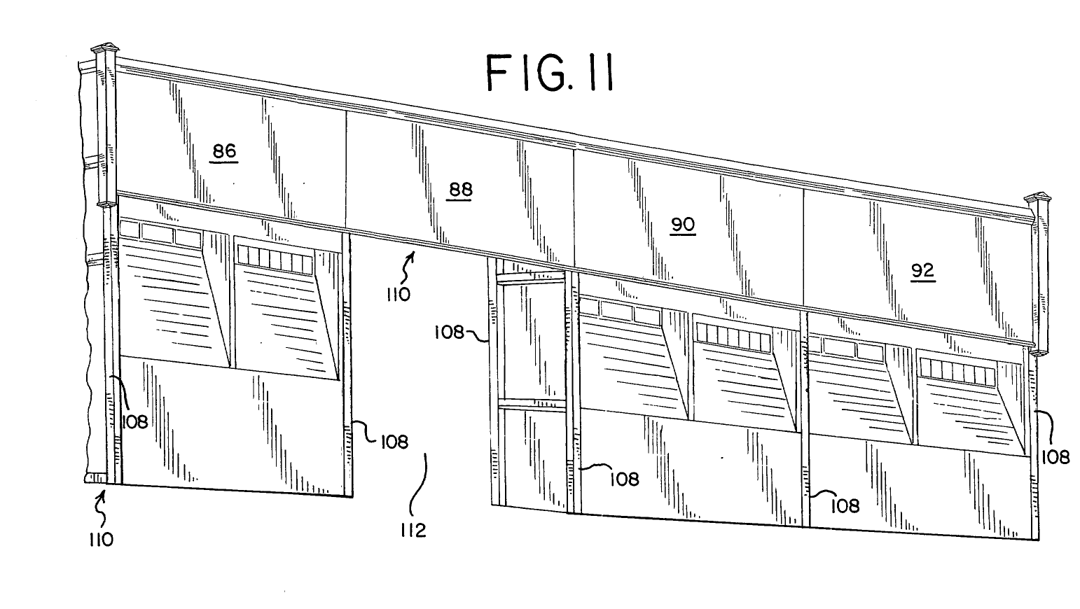

In a second embodiment of the invention, shown in FIGS. 11-18, the sliding doors are supported by a separate rigid frame 82 that may be secured to this same kind of H-frame rack system 110 as disclosed in the first embodiment.

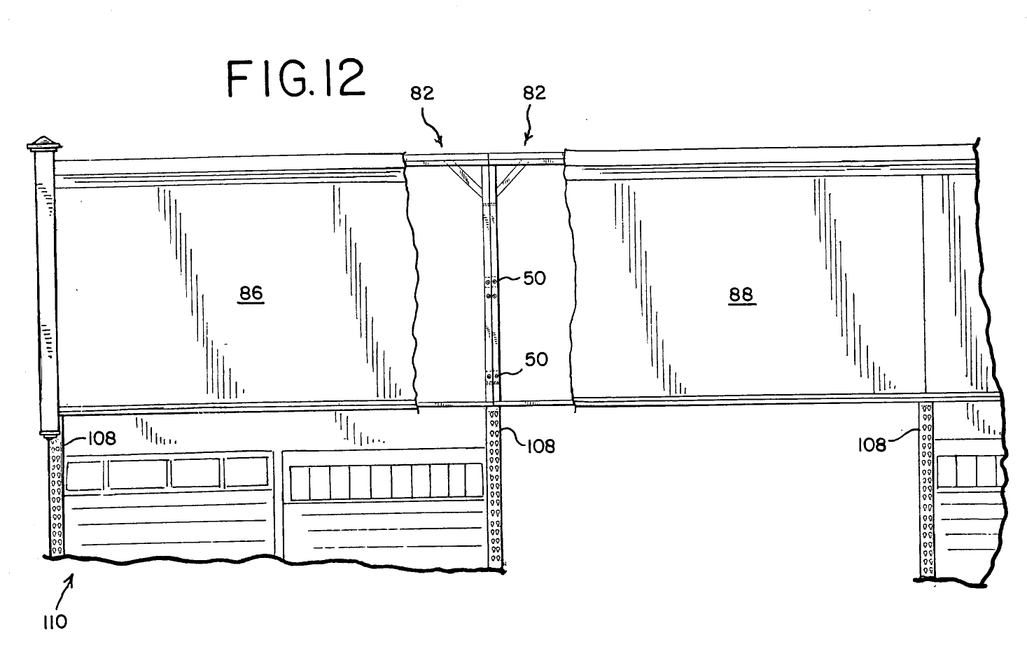

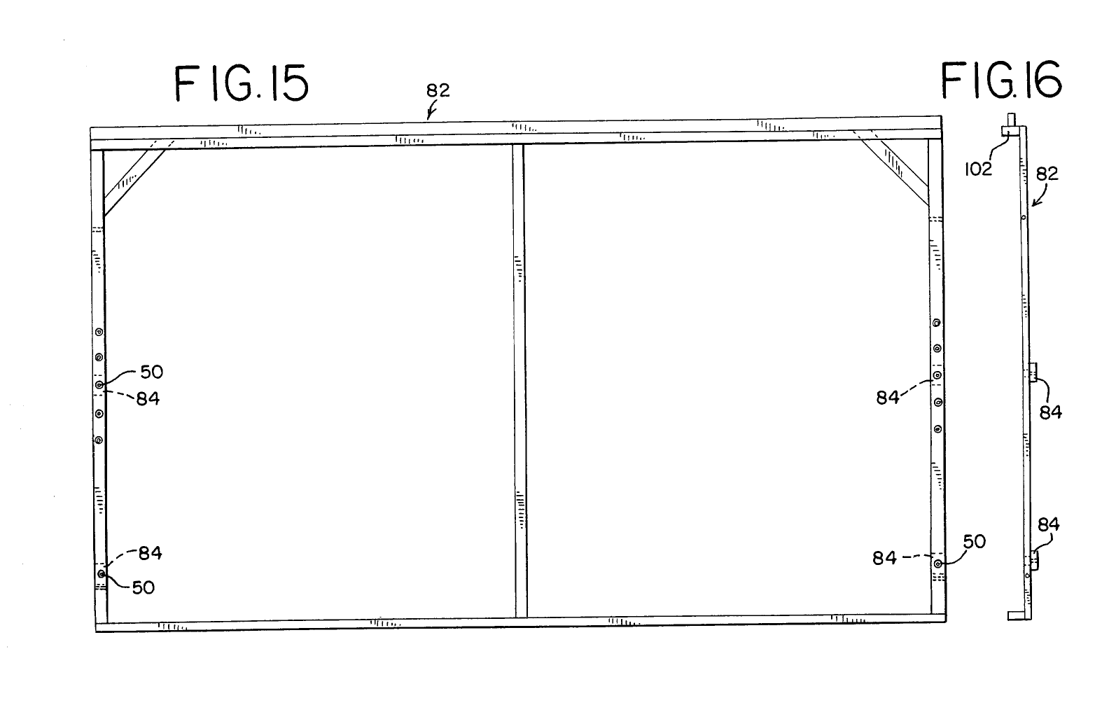

The rigid frame 82 itself is best shown in FIGS. 12, 15, and 16. The rigid frame 82 can be made of steel or any other lightweight, structurally strong material. In the embodiment of the present invention, the rigid support frame 82 of FIGS. 15 and 16 is made of 1×2-inch, 18-gauge rectangular steel tubing. A typical rigid support frame 82 has a length of slightly over ninety-nine (99) inches, a height of slightly less than sixty (60) inches, and a weight of about 34 pounds. The sliding doors of this embodiment are supported by this rigid support frame 82. As a result of this positioning, the sliding doors in this second embodiment are positioned outboard of a vertical plane extending between the front or face 118 of adjacent vertical posts 108 of the H-frame rack system 110.

In the embodiment of FIGS. 11-17, and as may best be seen in FIG. 13, the frame 82 is positioned so that the top 112 of the frame 82 is approximately even with the top 114 of the H-frame rack system 110.

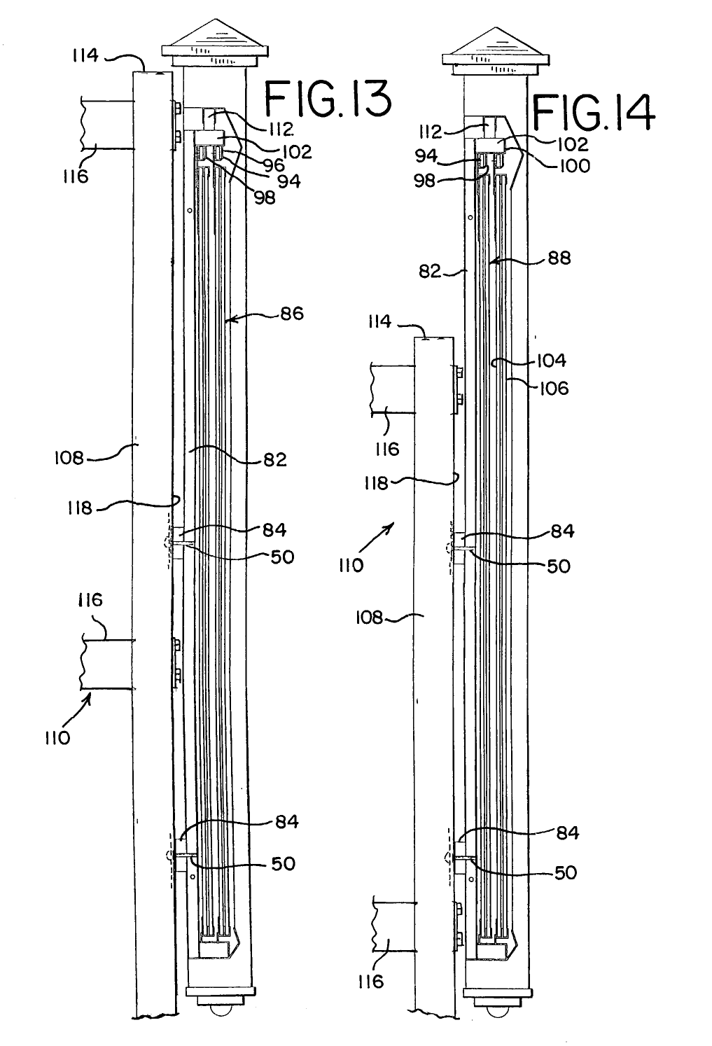

In contrast, as may best be seen in FIG. 14, the top 112 of the rigid support frame 82 may also be disposed well above the top 114 of the H-frame rack system 110. As may be seen in a comparison of FIGS. 13 and 14, this is effected by mounting the rigid support frame 82 at a higher point along the vertical posts 108.

Mounting hardware 50 (FIGS. 13 and 14) secures the frame 82 to the vertical posts 108 of the H-frame rack system 110. This mounting hardware 50 projects slightly outwardly from the face 118 of the vertical posts 108. Spacers 84 space the rigid support frame 82 away from the vertical posts 108 of the H-frame rack system 110.

In this embodiment, as may best be seen in FIG. 11, four sliding doors 86, 88, 90, and 92 are shown. These sliding doors 86, 88, 90, and 92 are laterally movable along the front of the H-frame rack system 110 by rollers or wheels, in a manner similar to the first embodiment. Unlike the first embodiment, however, which includes three tracks, this embodiment includes only two tracks 96 and 98. As may best be seen in FIGS. 13 and 14, the rollers 94 of the sliding door 86 move within the first track 96. The rollers 94 of the sliding door 88 move within the second track 98. The rollers (not shown) of door 90 move within the first track 96, while the rollers (not shown) of the door 92 move within the second track 98.

Furthermore, any number of additional sliding doors may be placed in this manner, with each adjacent door positioned upon a different track, and with every second or alternate door positioned upon the same track. Hence, two tracks can be used to accommodate an indefinite number of such sliding doors.

As may be seen in FIGS. 13 and 14, the tracks 96 and 98 are of a substantially J-shaped side profile. The tracks 96 and 98 are part of a one-piece structure 100 that may be extruded of plastics, such as polyvinylchloride (PVC) or acrylonitrile butadiene styrene (ABS). This structure 100 slides over, and is fixedly attached to, the rectangular tubing 102 (see FIG. 16) near the top of the rigid frame 82.

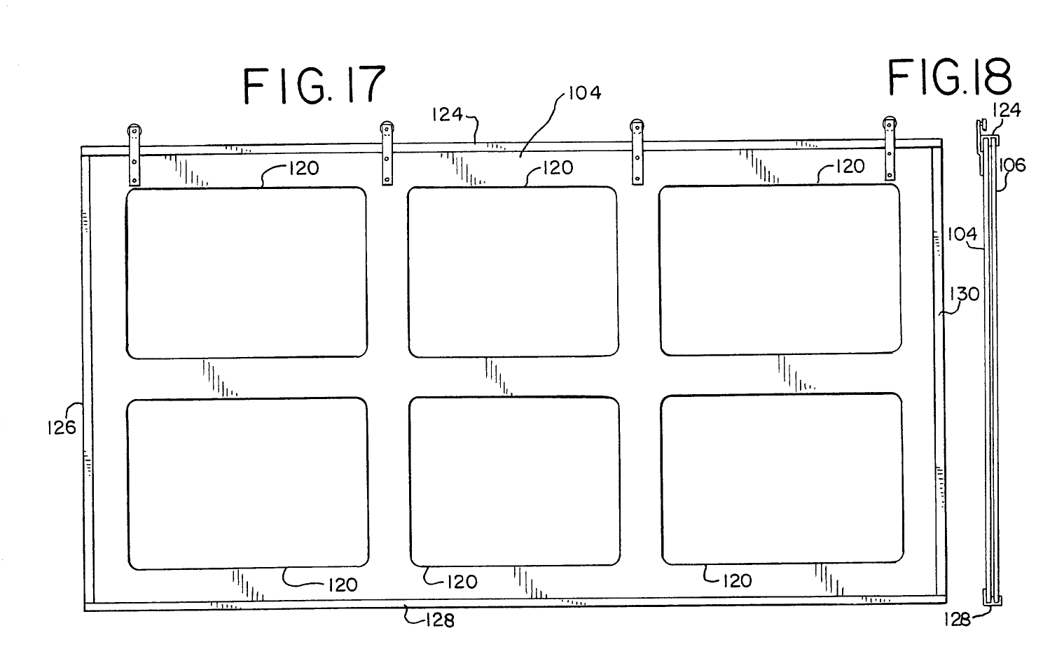

As may best be seen in FIGS. 13 and 14, the sliding doors include a structural panel 104 and a graphics panel 106. A frontal view of the structural panel 104 is shown in detail in FIG. 17. That panel 104 is preferably made of a thin ¼″ wooden hardboard material. The panel 104 includes six routed openings or apertures 120. These six openings 120 provide a place where the panel can be grasped, lighten that panel 104 to further ease handling, and aid in preventing warpage of the panel 104. In this preferred embodiment, this panel 104 has a length of approximately one-hundred inches, and a height of approximately fifty-three inches.

As may be seen in FIGS. 17 and 18, the sliding doors include a four framing elements 124, 126, 128, and 130. These framing elements 124, 126, 128, and 130 are extruded pieces which surround the elements of each sliding door. The framing elements 124, 126, 128, and 130 hold both the rear structural panel 104 and the front graphics panel 106 of this embodiment in a generally parallel relationship. The structural panel 104 and the graphics panel 106 of FIG. 18 slide into elongated slots created by the extruded framing elements 124, 126, 128, and 130.

Like the graphics panels 83 of the first embodiment, the graphics panel 106 of this second embodiment may be used to depict advertising or promotional messages. Because the doors 86, 88, 90, and 92 have relatively small framing portions, these doors can more readily be used to provide one continuous advertisement or message across two or more graphics panels 106 on two or more adjacent doors 86, 88, 90, and 92.

In this second embodiment, as depicted in FIG. 11, doors 86, 90, and 92 are positioned above merchandise. As may also be seen in this FIG. 11, this second embodiment with its rigid frame 82 also permits advertising to be positioned above an open aisle 112.

Additional advantages arise from this second embodiment. The length of the rigid frame 82 can be varied, to accommodate potentially differently sized H-frame rack systems 110. As noted above, two continuous, unobstructed tracks 96 and 98 can accommodate a virtually unlimited number of side-by-side doors. The second embodiment, like the first embodiment, is made from lightweight, readily available components and hardware.

It will be understood by those skilled in the art that in this second embodiment, the sliding door may be positioned in a manner, or may be of sufficient height, such that it obscures portions of at least two vertically-adjacent shelves in this H-frame rack system.

It is understood that, given the above description of the embodiments of the invention, various modifications may be made by one skilled in the art. Such modifications are intended to be encompassed by the claims below.

What is claimed is:

1. A sliding door system for an H-frame rack system, said H-frame rack system including a plurality of substantially vertical posts, and a plurality of substantially horizontal beams connected to said vertical posts, and substantially horizontal shelves supported by said horizontal beams, said sliding door system comprising (a) at least one sliding door; (b) rollers secured to said sliding door for facilitating lateral movement of said sliding door along said H-frame rack system; and (c) channels, above said sliding door and secured to said H-frame rack system, upon which said rollers are guided.

2. The sliding door assembly of claim 1, wherein said H-frame system further comprises a horizontal beam, and wherein said sliding door is positioned substantially inboard of a vertical plane extending from a front surface of said horizontal beam.

3. The sliding door assembly of claim 1, wherein said sliding door is supported by a separate frame secured to said H-frame rack system.

4. The sliding door assembly of claim 2, wherein said assembly comprises at least three (3) doors.

5. The sliding door assembly of claim 4, wherein said at least three (3) doors are all approximately the same length.

6. The sliding door assembly of claim 1, wherein the height of said sliding door is adjustable.

7. The sliding door assembly of claim 1, wherein said sliding door includes a plurality of panels, including an upper panel, a middle panel, and a lower panel, the middle panel being vertically adjustable relative to said upper panel and said lower panel.

8. The sliding door assembly of claim 6, wherein said sliding door includes a frame portion and a plurality of panels, including an upper panel, a middle panel, and a lower panel, the middle panel being vertically adjustable relative to said upper panel and said lower panel.

9. The sliding door assembly of claim 6, wherein said frame portion includes two oversized frame members.

10. The sliding door assembly of claim 1, wherein said sliding door is positioned outboard of a vertical plane extending between vertical posts.

11. The sliding door assembly of claim 10, wherein said sliding door is supported by a support frame that is secured to said H-frame rack system.

12. The sliding door assembly of claim 11, wherein the top of said support frame is disposed above the top of said H-frame rack system.

13. The sliding door assembly of claim 11, wherein said support frame includes spacers for spacing said support frame away from the vertical posts of said H-frame rack system.

14. The sliding door assembly of claim 11, wherein said sliding door is positioned so as to obscure portions of at least two vertically-adjacent shelves.
